(19) United States
(12) Patent Application Publication
(10) Pub. No.: US 2024/0200270 A1
(43) Pub. Date: Jun. 20, 2024

(54) METHOD FOR MANUFACTURING PAPER AND CARDBOARD

(71) Applicant: SPCM SA, ANDREZIEUX BOUTHEON (FR)

(72) Inventors: Cyril BARRIERE, ANDREZIEUX BOUTHEON (FR); Gatien FAUCHER, ANDREZIEUX BOUTHEON (FR); Bastien MARTEL, ANDREZIEUX BOUTHEON (FR)

(21) Appl. No.: 18/555,480

(22) PCT Filed: Apr. 13, 2022
(86) PCT No.: PCT/EP2022/059954

§ 371 Date: Oct. 13, 2023

(30) Foreign Application Priority Data
Apr. 15, 2021 (FR) 2103912

(51) Int. Cl. D21H 17/37; C08F 120/56; D21H 21/10; D21H 21/18; D21H 23/04

(52) U.S. Cl. CPC D21H 17/375; C08F 120/56; D21H 21/10; D21H 21/18; D21H 23/04; C08F 2810/00

(57) ABSTRACT

A method for producing a sheet of paper or cardboard from a fibrous suspension includes injection of a polymer P2 into a suspension of cellulosic fibers, forming of a sheet of paper or cardboard, and drying of the sheet of paper or cardboard. The polymer P2 is prepared, before the injection, from a water-soluble polymer P1 in inverse emulsion form. P1 consists of at least one nonionic monomer selected from acrylamide, methacrylamide, N,N-dimethylacrylamide, and acrylonitrile. The polymer P1 is subjected to a reaction Re to yield a polymer P2. The reaction Re includes adding the polymer P1 in inverse emulsion form to an aqueous solution M1 of an alkali hydroxide and/or an alkaline earth hydroxide, and an alkali hypohalide and/or an alkaline earth hypohalide, prior to a reaction time of 10 seconds to 5 hours.

### FIELD OF THE INVENTION

The present invention relates to a method for producing paper or cardboard having improved drainage and machinability properties. More precisely, the invention relates to a method involving the reaction of a water-soluble polymer in inverse emulsion form in a mixture of alkali hydroxide and/or of alkaline earth hydroxide and of alkali hypohalide and/or of alkaline earth hypohalide to be injected later directly into the fibrous suspension used to produce the paper or the cardboard.

The present invention also relates to paper and cardboard having the improved physical properties obtained by this method.

### PRIOR ART

The paper industry is constantly seeking to optimize its paper or cardboard production methods, more particularly in terms of yield, productivity, cost reduction, and quality of the finished products.

The use of polymers as agents for dry strength, drainage and machinability has been described very extensively.

The drainage properties relate to the capacity of the fibrous mat to remove or drain the maximum amount of water before the dryer section. Improved drainage properties involve energy savings and an increase of the production capacity.

Machinability designates the optimization of the operation of the paper-making machine by increasing the productivity due to better drainage on the table, better dryness in the press section, less breakage due to greater cleanliness of the circuits and less deposition.

JP 2002-212898 describes the use of a polymer obtained by the Hofmann degradation reaction in a paper-making method. This document does not describe, during a chemical reaction, the addition of a polymer in the form of an inverse emulsion.

WO 2020/094960 describes inverse emulsion compositions. EP 2 840 100 the functionalization of a polymer.

Polyvinylamines are known to improve drainage during the forming of the paper.

Polyvinylamines can be obtained by reacting a solution of polyacrylamide in a mixture of alkali hydroxide and/or of alkaline earth hydroxide and of alkali hypohalide and/or of alkaline earth hypohalide followed by treatment in an acidic medium.

When the reaction is carried out directly before injection of the product into the fibrous suspension for obtaining the paper or the cardboard, only the reaction of the polyacrylamide in solution with the alkali or alkaline earth hydroxides and hypohalides is carried out.

However, this necessity of having polyacrylamide solutions implies their transport to the paper mill or the necessity of having equipment for dissolving the polymer in the paper mill. In both cases, the footprint of the stocks of polymer solutions or of the dissolution equipment remains large.

In addition, this reaction on the polyacrylamide requires heating the reaction medium and also requires an exchanger in order to regulate its temperature at the end of the reaction.

### DESCRIPTION OF THE INVENTION

Unexpectedly, the Applicant discovered that a method involving the reaction of a water-soluble polymer in inverse emulsion form (water-in-oil) in a mixture of hydroxide (alkali metal hydroxide and/or alkaline earth metal hydroxide) and of hypohalide (alkali metal hypohalide and/or alkaline earth metal hypohalide), to be then injected directly into the fibrous suspension used to produce the paper or the cardboard makes it possible to improve the drainage and dry strength properties.

This method also makes it possible to avoid a whole logistics scheme (transport or installation of a dissolution unit) inherent in the handling of solutions of water-soluble polymers.

In addition, the method becomes simpler since, from the time of the addition of the polymer in inverse emulsion form to the mixture of alkali and/or alkaline earth hydroxide and hypohalide, the reaction medium is homogenous, and it is not necessary to heat the reaction medium or to use heat exchangers.

“Alkali” designates an alkali metal, advantageously lithium, sodium or potassium. An “alkali hydroxide” designates a hydroxide (OH⁻) of at least one alkali metal, for example, NaOH, KOH or NaOH+KOH. The same applies for the alkaline earth hydroxide.

“Alkaline earth” designates an alkaline earth metal, advantageously calcium or magnesium.

A hypohalide is an oxyanion, for example, hypochlorite ClO⁻.

An “alkali hypohalide” designates a hypohalide of at least one alkali metal and at least one hypohalide, for example, NaOCl, KOBr or NaOCl+KOBr. The same applies for the alkaline earth hypohalide.

Finally, since the range of molecular weights of the water-soluble polymers in inverse emulsion form is large, the method of the invention makes it possible to increase the current range of drainage and dry strength agents compared to a similar method using polyacrylamides in the form of an aqueous solution.

More precisely, the invention relates to a method for producing a sheet of paper or cardboard from a fibrous suspension, comprising the following steps:
a) injection of a polymer P2 into a fibrous suspension (advantageously a suspension of cellulosic fibers),
b) forming of a sheet of paper or cardboard,
c) drying of the sheet of paper or cardboard,
the polymer P2 being prepared, before step a), from a water-soluble polymer P1 in inverse emulsion form, P1 being a water-soluble polymer of at least one nonionic monomer selected from acrylamide, methacrylamide, N,N-dimethylacrylamide, and acrylonitrile,
the polymer P2 being obtained by a reaction Re comprising adding the water-soluble polymer P1 in inverse emulsion form to an aqueous solution M1 of: (i) an alkali metal hydroxide, or an alkaline earth metal hydroxide, or mixtures thereof, (ii) an alkali metal hypohalide, or an alkaline earth metal hypohalide, or mixtures thereof,
the reaction Re having a reaction time of 10 seconds to 5 hours after the addition of the water-soluble polymer P1 in inverse emulsion form.

Advantageously, step a) is carried out within a time period not exceeding 24 hours counting from the start of the reaction Re, that is to say counting from the addition of the water-soluble polymer P1 in inverse emulsion form to the aqueous solution M1.

In the continuation of the description and in the claims, all the polymer dosages expressed in g·t⁻¹ or kg·t⁻¹ are given in weight of polymer per tonne of dry matter. The dry matter corresponds to the dry extract obtained after evaporation of the water from the fibrous suspension used in a method for producing a sheet of paper or cardboard. The dry matter is generally based on cellulosic fibers and fillers, advantageously consisting of cellulosic fibers and fillers. The term “cellulosic fibers” encompasses any cellulosic entity comprising fibers, fines, microfibrils or nanofibrils. Fibrous suspension is understood to mean the thick pulp or the diluted pulp based on water and cellulosic fibers. The thick pulp (Thick Stock) having a dry matter mass concentration generally greater than 1%, or even greater than 3%, is upstream of the mixing pump (fan-pump). The diluted pulp (Thin Stock) having a dry matter mass concentration generally less than 1% is located downstream of the mixing pump.

The term “polymer” designates homopolymers as well as copolymers of at least two different monomers.

An amphoteric polymer is a polymer comprising cationic charges and anionic charges, preferably as many anionic charges as cationic charges.

As used here, the term “water-soluble polymer” designates a polymer which yields an aqueous solution with no insoluble particles when it is dissolved under stirring for 4 hours at 25° C. and at a concentration of 20 g·L⁻¹ in deionized water.

The ranges of values include the lower and upper limits. Thus, the ranges of values “between 0.1 and 1.0” and “from 0.1 to 1” include the values 0.1 and 1.0.

The water-soluble polymer P1 is a polymer of at least one nonionic monomer selected from acrylamide, methacrylamide, N, N-dimethylacrylamide, and acrylonitrile. Preferably, the polymer P1 contains at least 50 mol % of at least one of these nonionic monomers.

The polymer P1 can also contain anionic and/or cationic and/or zwitterionic monomers. The polymer P1 advantageously is free of nonionic monomer not selected from acrylamide, methacrylamide, N,N-dimethylacrylamide, and acrylonitrile.

The anionic monomers are preferably selected from the group comprising the monomers having a carboxylic acid function and salts thereof including acrylic acid, methacrylic acid, itaconic acid, maleic acid, the monomers having a sulfonic acid function and salts thereof; including acrylamide tertiary-butyl sulfonic acid (ATBS), allyl sulfonic acid, and methallyl sulfonic acid, and salts thereof, and the monomers having a phosphonic acid function and salts thereof.

In general, the anionic monomers of the polymer P1 have, as counterion, an alkali metal, an alkaline earth metal or an ammonium (preferably a quaternary ammonium).

The cationic monomers are preferably selected from the group comprising quaternized acrylate (ADAME), quaternized or salified or salified dimethylaminoethyl dimethylaminoethyl methacrylate (MADAME), diallyldimethylammonium chloride (DADMAC), acrylamidopropyltrimethylammonium chloride (APTAC), and methacrylamidopropyltrimethylammonium chloride (MAPTAC).

Advantageously, the cationic monomers of the polymer P1 have, as counterion, a halide, preferably a chloride ion.

The zwitterionic monomers are preferably selected from the group comprising the sulfobetaine monomers such as sulfopropyl dimethylammonium ethylmethacrylate, sulfopropyl dimethylammonium propylmethacrylamide, or sulfopropyl-2-vinylpyridinium; the phosphobetaine monomers such as phosphate ethyltrimethylammonium ethylmethacrylate; and the carboxybetaine monomers.

Preferably, the water-soluble polymer P1 is a homopolymer or a copolymer of acrylamide or of methacrylamide.

The polymer P1 can be linear, structured or cross-linked. The cross-linking agents enabling the structuring can notably be selected from sodium allyl sulfonate, sodium methallyl sulfonate, sodium methallyl disulfonate, methylenebisacrylamide, triallylamine, triallylammonium chloride.

The structuring of the polymer P1 can also be obtained with at least one polyfunctional compound containing at least 3 heteroatoms selected from N, S, O, P and each having at least one mobile hydrogen. This polyfunctional compound can notably be a polyethyleneimine or a polyamine.

The reaction Re is carried out by addition of an inverse emulsion of water-soluble polymer P1 to the aqueous solution M1. Preferably, the inverse emulsion (water-in-oil emulsion) comprises:
An aqueous phase comprising at least the polymer P1,
An oil phase,
At least one emulsifying agent and at least one inversion agent.

The oil phase can be a mineral oil, a vegetable oil, a synthetic oil or a mixture of several of these oils.

Examples of mineral oil are mineral oils containing saturated hydrocarbons of aliphatic, naphthenic, paraffinic, isoparaffinic, cycloparaffinic or naphthyl type.

Examples of synthetic oil are hydrogenated polydecene or hydrogenated polyisobutene, an ester such as octyl stearate or butyl oleate. The Exxsol® product line from Exxon is perfectly suitable.

In general, the ratio by weight of the aqueous phase to the oil phase in the inverse emulsion is preferably from 50/50 to 90/10. This ratio includes the weight of the different constituents of the emulsion, notably the water-soluble polymer P1.

The water-in-oil emulsion preferably comprises from 15 to 40% by weight of oil, from 20 to 55% by weight of water, from 15 and 50% by weight of polymer P1, the percentages being expressed with respect to the total weight of the inverse emulsion of the polymer P1.

In the present invention, the term “emulsifying agent” designates an agent capable of emulsifying water in an oil, whereas an “inversion agent” is an agent capable of emulsifying an oil in water. More precisely, an inversion agent is considered to be a surfactant having an HLB greater than or equal to 10, and an emulsifying agent is considered to be a surfactant having an HLB strictly less than 10.

The hydrophilic-lipophilic balance (HLB) of a chemical compound is a measure of its degree of hydrophilicity or lipophilicity, determined by calculating the values of the different regions of the molecule, as described by Griffin in 1949 (Griffin, WC, Classification of Surface-Active Agents by HLB, Journal of the Society of Cosmetic Chemists, 1949, 1, pages 311-326).

In the present invention, we adopted the Griffin method based on the calculation of a value based on the chemical groups of the molecule. Griffin assigned a dimensionless number between 0 and 20 in order to give information on the solubility in water and in oil. The substances having an HLB value of 10 are distributed between the two phases, so that the hydrophilic group (molecular weight Mh) extends completely into the water, while the hydrophobic hydrocarbon group (molecular weight Mp) is adsorbed in the non-aqueous phase.

The HLB value of a substance having a total molecular weight M, the hydrophilic portion of which has a molecular weight Mh, is HLB=20 (Mh/M).

The inverse emulsion containing the polymer P1 advantageously contains from 0.1% to 10% by weight of at least one emulsifying agent, the percentages being expressed by weight with respect to the weight of the emulsion. This emulsifying agent is advantageously selected from sorbitan esters, polyethoxylated sorbitan esters, polyethoxylated fatty acids, polyethoxylated fatty alcohols, polyesters having an average molecular weight between 1000 and 3000 daltons resulting from the condensation between a poly(isobutenyl) succinic acid or its anhydride and a polyethylene glycol, block copolymers having an average molecular weight between 2500 and 3500 daltons resulting from the condensation between hydroxystearic acid and a polyethylene glycol, ethoxylated fatty amines, derivatives of the dialkanolamides, copolymers of stearyl methacrylate, and mixtures of these emulsifying agents.

The inverse emulsion containing the polymer P1 advantageously contains between 0.1 and 10% by weight of at least one inversion agent, the percentages being expressed in weight with respect to the weight of the emulsion. This inversion agent is advantageously selected from ethoxylated nonylphenols preferably having 4 to 10 ethoxylations, ethoxylated/propoxylated alcohols preferably having an ethoxylation/propoxylation comprising between 12 and 25 carbon atoms; ethoxylated tridecylic alcohols, polyethoxylated fatty acids, poly(ethoxylated/propoxylated) fatty alcohols; ethoxylated sorbitan esters; polyethoxylated sorbitan laurate; polyethoxylated castor oil; heptaoxyethylated lauric alcohol; polyethoxylated sorbitan monostearate;

polyethoxylated alkylphenol cetyl ether; polyethylene oxide alkylaryl ether; N-cetyl-N-ethyl morpholinium ethosulfate; sodium lauryl sulfate; products of condensation of fatty alcohols with ethylene oxide; products of condensation of alkylphenols and ethylene oxide;

products of condensation of fatty amines with 5 molar equivalents or more of ethylene oxide; ethoxylated tristyryl phenols; condensates of ethylene oxide with polyhydric alcohols partially esterified with fatty chains as well as anhydrous forms thereof; amine oxides; alkyl polyglucosides; glucamide; phosphate esters; alkylbenzene sulfonic acids and salts thereof; water-soluble surfactant polymers; and mixtures of several of these inversion agents.

The water-in-oil emulsion according to the invention can be prepared by any method known to a person skilled in the art. In general, an aqueous solution comprising the monomer(s) and the emulsifying agent(s) is emulsified in an oil phase. Then, the polymerization is carried out by adding a free radical initiator. Reference can be made to the redox pairs, with cumene hydroperoxide, tertiary butylhydroxyperoxide or persulfates among the oxidizing agents, sodium sulfite, sodium metabisulfite and Mohr's salt among the reducing agents. Azoic compounds such as hydrochloride of 2,2′-azobis (isobutyronitrile) and of 2,2′-azobis (2-amidinopropane) can also be used.

Conventionally, the polymerization is generally carried out isothermally, adiabatically or at controlled temperature. Thus, the temperature is advantageously kept constant, in general between 10 and 60° C. (isothermal), or the temperature is allowed to increase naturally (adiabatic) and in this case the reaction is generally started at a temperature below 10° C. and the final temperature is generally higher than 50° C., or finally, the increase of the temperature is controlled so as to have a temperature curve between the isothermal curve and the adiabatic curve.

In general, the inversion agent(s) is/are added at the end of the polymerization reaction, preferably at a temperature below 50° C.

The reaction Re comprises adding the inverse emulsion of polymer P1 to an aqueous solution M1 of: (i) an alkali hydroxide and/or an alkaline earth hydroxide, (ii) an alkali hypohalide and/or an alkaline earth hypohalide, with a time of reaction Re of 10 seconds to 5 hours in order to form the polymer P2.

Advantageously, the aqueous solution M1 is an aqueous solution of soda (sodium hydroxide) and sodium hypochlorite.

Advantageously, the reaction time of the polymer P1 in the aqueous solution M1 of hypohalide and hydroxide is 10 seconds to 180 minutes.

The reaction Re is advantageously carried out at a temperature between 10 and 30° C., more advantageously between 15 and 25° C.

Preferably, for the reaction Re, the coefficient Alpha=moles of (alkali and/or alkaline earth) hypohalide/moles of nonionic monomer(s) (acrylamide, methacrylamide, N,N-dimethylacrylamide, acrylonitrile or mixtures thereof) of the polymer P1 is between 0.1 and 1.0, and the coefficient Beta=moles of (alkali and/or alkaline earth) hydroxide/moles of (alkali and/or alkaline earth) hypohalide is between 0.5 and 4.0.

For the reaction Re, preferably between 0.1 and 20% by weight of polymer P1, with respect to the weight of the aqueous solution M1, more preferably between 0.3 and 10%, and even more preferably between 0.5 and 3.0% by weight, are added to the aqueous solution M1.

Advantageously, at the end of the reaction Re and before its injection into the fibrous suspension, the polymer P2 can be functionalized with a compound comprising at least one aldehyde function in order to yield a polymer P3, for example by addition of a compound comprising at least one aldehyde function. Preferably, the compound comprising at least one aldehyde function is glyoxal.

Preferably, before injection into the fibrous suspension, the pH of the reaction mixture obtained by the reaction Re and containing the polymer P2 can be adjusted by addition of acid between 0.5 and 7.5, more preferably between 1.0 and 3.0. A person skilled in the art knows how to adjust the pH of this type of reaction medium. The adjustment of the pH is advantageously carried out in the absence of formation of the polymer P3.

According to a preferred embodiment, the polymer P2 (or P3) is introduced into the white water and/or the thick pulp and/or the mixture formed by the white water and the thick pulp after homogenization of the fibrous suspension in the dilution pump (fan pump).

Advantageously, the polymer P2 (or P3) can also be introduced within the paper-making process at the forming table, for example, by spraying or application in the form of a foam, or else at the size press (coating machine).

Advantageously, between 0.1 and 10 kg·t⁻¹ and preferably between 0.2 and 5.0 kg·t⁻¹ of polymer P2 (or P3) are added to the fibrous suspension.

The fibrous suspension encompasses the possible use of different cellulosic fibers: virgin fibers, recycled fibers, chemical pulp, mechanical pulp, microfibrillated cellulose or nanofibrillated cellulose. The fibrous suspension also encompasses the use of these different cellulosic fibers with all types of fillers such as TiO₂, CaCO₃ (crushed or precipitated), kaolin, organic fillers and mixtures thereof.

The polymer P2 or P3 can be used within the paper-making process in combination with other products such as mineral or organic coagulants, dry strength agents, wet strength agents, natural polymers such as starches or carboxymethylcellulose (CMC), inorganic microparticles such as bentonite microparticles and colloidal silica microparticles, organic polymers of any ionic type (nonionic, cationic, anionic, or amphoteric) and which can be (without being limited to) linear, branched, crosslinked, hydrophobic or associative polymers.

The following examples illustrate the invention without, however, limiting its scope.

### EMBODIMENT EXAMPLES OF THE INVENTION

### Procedures Used in the Application Tests:

### a) Types of Pulps Used

Pulp of recycled fibers: The wet pulp is obtained by disintegration of dry pulp in order to obtain a final aqueous concentration of 1% by weight. This is a pulp with a neutral pH consisting of 100% of fibers of recycled cardboard.

### b) Evaluation of the Drainage Performances (DDA)

The DDA (“Dynamic Drainage Analyzer”) enables one to determine automatically the time (in seconds) necessary to vacuum drain a fibrous suspension deposited on a fabric. The polymers are added to the wet pulp (0.6 liter of pulp at 1.0% by weight) in the cylinder of the DDA under stirring at 1000 rpm:
T=0 s: stirring of the pulp
T=20 s: Addition of the polymer
T=30 s: stopping of the stirring and vacuum drainage at 200 mbar (1 bar=105 Pa) for 70 seconds.

The pressure under the fabric is recorded as a function of time. When all the water has been removed from the fibrous mat, the air passes through said mat causing a break in slope of the curve representing the pressure under the fabric as a function of time. The time, expressed in seconds, recorded at this break in slope corresponds to the drainage time. The shorter the time, the better the vacuum drainage thus is.

c) Performances in DSR (Dry Strength) Application, Grammage at 90 g·m⁻²

The necessary quantity of pulp is collected so as to obtain a sheet having a grammage of 90 g·m⁻².

The wet pulp is introduced into the vat of the dynamic sheet former and maintained under stirring. The different components of the system are injected into this pulp according to the predefined sequence. In general, a contact time of 30 to 45 seconds is complied with between each addition of polymer.

Paper sheet formers are implemented with an automatic dynamic sheet former: a blotting paper and the forming fabric are placed in the drum of the dynamic sheet former before starting the rotation of the drum at 1000 rpm and forming the wall of water. The treated pulp is distributed over the wall of water in order to form the fibrous mat on the forming fabric.

Once the water is drained, the fibrous mat is recovered, pressed under a press delivering 4 bars, and then dried at 117 ºC. The sheet obtained is conditioned for one night in a room with controlled humidity and temperature (50% relative humidity and 23° C.). The dry strength properties of all the sheets obtained by this procedure are then measured.

The bursting (Burst Index) is measured with a Messmer Buchel M 405 bursting tester according to the standard TAPPI T403 om-02. The result is expressed in kPa or as a percentage with respect to a reference. The burst index, expressed in kPa·m²/g, is determined by dividing this value by the grammage of the tested sheet.

The dry breaking length is measured in the machine direction (DBL SM) and in the traverse direction (DBL ST) using a Testometric AX traction apparatus according to the standard TAPPI T494 om-01. The result is expressed in km or as a percentage with respect to a reference.

### Products Tested in the Application Tests:

### Polymers P1

### Synthesis of Polymer P1-A

310 g of water are introduced into a 1-liter reactor equipped with a mechanical stirrer, a thermometer, a condenser, and a gaseous nitrogen immersion rod. The pH of the reaction medium is adjusted to 3.3 using a pH buffer (NaOH 30% by weight in water and H₃PO₄ 75% by weight in water). The medium is heated and maintained at a temperature between 79 and 81° C. using a water bath. Using two continuous fluid flows, 400 g of acrylamide at 50%, 237.8 g of water and 2.40 g of sodium hypophosphite at 100% (fluid flow 1) are incorporated for 180 minutes. Fluid flow 2, 0.48 g of sodium persulfate at 100% and 48 g of water for 180 minutes. The polymer solution is maintained at 80° ° C. for 120 minutes after the end of the fluid flow.

The solution of polymer P1-A obtained has a pH of 5.7, a concentration by weight of polymer P1-A of 20%, and a viscosity of 6000 cps.

Polymer P1-B: Homopolymer of acrylamide in inverse emulsion form marketed by SNF under the name: Flopam™ EM 230.

The polymers P1-A (in aqueous solution) and P1-B (inverse emulsion) are homopolymers of acrylamide which differ only by their physical form.

### Polymers P2

### Synthesis of Polymer P2-A

Preparation of a solution of P1-A at 10% by weight in water, by diluting 20 g of a solution of P1-A at 20% by weight in water with 20 g of water. The solution of polymer is heated to 50° C.

An aqueous solution of 14.29 g of sodium hypochlorite (NaOCl) at 14.6% (by weight in water) and 7.5 g of soda at 30% (by weight in water) is prepared as a function of the coefficients alpha (0.5) and beta (2.0) for the reaction Re. When the solution of polymer P1-A is at 50° C., the aqueous solution of sodium hypochlorite and soda is added on P1-A. After 30 seconds of reaction, 138.20 g of water are added. A solution of polymer P2-A at a concentration of 2% by weight is obtained.

### Synthesis of Polymer P2-B

An aqueous solution M1 of 3.66 g of sodium hypochlorite (NaOCl) at 14.6% (by weight in water) and 1.92 g of soda at 30% (by weight in water) is prepared as a function of the coefficients alpha (0.5) and beta (2.0) for the reaction Re. 93.60 g of water are then added.

3.20 g of polymer P1-B (in inverse emulsion) are added to the aqueous solution M1 at ambient temperature and under stirring. The polymer is stirred for 60 minutes in the solution M1. A solution of polymer P2-B, at a final concentration by weight of polymer equal to 1%, is obtained.

### Application Tests

### Drainage Performances (DDA)

TABLE 1
Drainage as a function of the polymer.

| | Drainage (s) | |
|---|---|---|
| | 1.7 kg/T | 3.4 kg/T |
| P2-A | 21.04 | 15.65 |
| P2-B | 11.83 | 7.42 |

| | |
|---|---|
| Blank | 34.39 |

An improvement of the drainage is observed with the use of the polymer P2-B with respect to the polymer P2-A.

### Performances in DSR (Dry Strength) Application

TABLE 2
Dry strength as a function of the polymer.

| | % Burst | % DBL | |
|---|---|---|---|
| | index | SM | % DBL ST |
| Blank | ref. | ref. | ref. |
| P2-A | 17% | 14% | 27% |
| P2-B | 31% | 19% | 47% |

The Burst performances are improved by the use of the polymer P2-B. The same trend is observed for the measurement of the breaking length in the machine direction (DBL SM) and in the traverse direction (DBL ST).

1. A method for producing a sheet of paper or cardboard from a fibrous suspension, comprising:
a) injecting a polymer P2 into a fibrous suspension,
b) forming of a sheet of paper or cardboard,
c) drying of the sheet of paper or cardboard,
wherein the polymer P2 is prepared, before said a), from a water-soluble polymer P1 in an inverse emulsion form, the water-soluble polymer P1 is a water-soluble polymer of at least one nonionic monomer selected from the group consisting of acrylamide, methacrylamide, N,N-dimethylacrylamide, and acrylonitrile,
wherein the polymer P2 is obtained by a reaction Re comprising adding the water-soluble polymer P1 in the inverse emulsion form to an aqueous solution M1 comprising (i) an alkali metal hydroxide, or an alkaline earth metal hydroxide, or mixtures thereof and (ii) an alkali metal hypohalide, or an alkaline earth metal hypohalide, or mixtures thereof,
the reaction Re has a reaction time of 10 seconds to 5 hours after the addition of the water-soluble polymer P1 in the inverse emulsion form.

2. The method according to claim 1, wherein the polymer P1 contains at least 50 mol % of at least one nonionic monomer selected from the group consisting of acrylamide, methacrylamide, N,N-dimethylacrylamide, and acrylonitrile.

3. The method according to claim 1, wherein the polymer P1 is a homopolymer or a copolymer of acrylamide or of methacrylamide.

4. The method according to claim 1, wherein the inverse emulsion comprises:
an aqueous phase comprising at least the polymer P1,
an oil phase,
at least one emulsifying agent and at least one inversion agent.

5. The method according to claim 1, wherein the inverse emulsion of the polymer P1 comprises from 15 to 40% by weight of oil, from 20 to 55% by weight of water, from 15 and 50% by weight of polymer, the percentages being expressed with respect to the total weight of the inverse emulsion of the polymer P1.

6. The method according to claim 1, wherein, for the reaction Re, the coefficient Alpha=moles of hypohalide/moles of nonionic monomer of the polymer P1 is between 0.1 and 1.0 and the coefficient Beta=moles of hydroxide/moles of hypohalide is between 0.5 and 4.0.

7. The method according to claim 1, wherein between 0.1 and 20% by weight of polymer P1, with respect to the weight of the aqueous solution M1, are added to the aqueous solution M1.

8. The method according to claim 1, wherein, at the end of the reaction Re, and before the injection into the fibrous suspension, the polymer P2 is functionalized with a compound comprising at least one aldehyde function to yield a polymer P3.

9. The method according to claim 8, wherein the compound comprising at least one aldehyde function is glyoxal.

10. The method according to claim 1, wherein, before the injection into the fibrous suspension, the pH of the reaction mixture obtained by the reaction Re and containing the polymer P2 is adjusted by addition of acid between 0.5 and 7.5.

11. The method according to claim 1, wherein the polymer P2 or P3 is introduced into the white water and/or into the thick pulp and/or into the mixture formed by the white water and the thick pulp after homogenization of the fibrous suspension in the dilution pump.

12. The method according to claim 1, wherein said a) is carried out within a time period not exceeding 24 hours counting from the addition of the water-soluble polymer P1 in the inverse emulsion form to the aqueous solution M1.

13. The method according to claim 1, wherein the aqueous solution M1 is an aqueous solution of sodium hydroxide and sodium hypochlorite.

14. The method according to claim 1, wherein the reaction Re is carried out at a temperature between 10 and 30° C.

15. The method according to claim 1, wherein between 0.3 and 10% by weight of polymer P1, with respect to the weight of the aqueous solution M1, are added to the aqueous solution M1.

16. The method according to claim 1, wherein the reaction Re is carried out at a temperature between 15 and 25° C.
